(19) United States
(12) Patent Application Publication
(10) Pub. No.: US 2014/0023047 A1
(43) Pub. Date: Jan. 23, 2014

(54) COMMUNICATION DEVICE AND METHOD FOR CONTROLLING PACKET GENERATION

(71) Applicants: Volker Aue, Dresden (DE); Frank Kowalewski, Goettingen (DE); Thomas Luetzenkirchen, Taufkirchen (DE)

(72) Inventors: Volker Aue, Dresden (DE); Frank Kowalewski, Goettingen (DE); Thomas Luetzenkirchen, Taufkirchen (DE)

(73) Assignee: INTEL MOBILE COMMUNICATIONS GMBH, Neubiberg (DE)

(21) Appl. No.: 13/550,620

(22) Filed: Jul. 17, 2012

(51) Int. Cl. H04W 72/04; H04W 72/12

(52) U.S. Cl. 370/336; 370/328

(57) ABSTRACT

According to an aspect of this disclosure, a communication device is provided comprising a first interface configured to receive a first packet supplied by a packet encoder; a determiner configured to determine a time difference between the time at which the first packet is ready to be sent by the communication device and a time at which communication resources for sending the first packet are available; a generator configured to generate information from which it is derivable when a second packet should be provided by the packet encoder based on the time difference; and a second interface configured to transmit the information to the packet encoder.

### TECHNICAL FIELD

Aspects of this disclosure generally relate to a communication device and a method for controlling packet generation.

### BACKGROUND

For the communication of two or more users via a communication network, e.g. real-time communication via speech or video, a low latency of the communication connection used for transmitting the communication data is typically desired to enhance user experience. Therefore, it is desirable to reduce latency in the transmission of media (e.g. speech) data.

### SUMMARY

According to an aspect of this disclosure, a communication device is provided including a first interface configured to receive a first packet supplied by a packet encoder; a determiner configured to determine a time difference between the time at which the first packet is ready to be sent by the communication device and a time at which communication resources for sending the first packet are available; a generator configured to generate information from which it is derivable when a second packet should be provided by the packet encoder based on the time difference; and a second interface configured to transmit the information to the packet encoder.

According to another aspect of this disclosure, a controlling packet generation according to the communication device described above is provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the aspects of this disclosure. In the following description, various aspects of this disclosure are described with reference to the following drawings, in which:

FIG. 1 shows a communication system according to an aspect of this disclosure.

FIG. 2 shows a communication device.

FIG. 3 shows a flow diagram.

FIG. 4 shows a transmission diagram.

FIG. 5 shows a transmission diagram.

FIG. 6 shows a data flow diagram and a timing diagram.

FIG. 7 shows a communication arrangement.

FIG. 8 shows a timing diagram illustrating omitting speech signal segments for speech packet re-timing.

FIG. 9 shows a timing diagram illustrating compressing speech signal segments for speech packet re-timing.

### DESCRIPTION

The following detailed description refers to the accompanying drawings that show, by way of illustration, specific details and embodiments in which the various aspects of this disclosure may be practiced. These embodiments are described in sufficient detail to enable those skilled in the art to practice the aspects. Other embodiments may be utilized and structural, logical, and electrical changes may be made without departing from the scope of the aspects. The various embodiments are not necessarily mutually exclusive, as some embodiments can be combined with one or more other embodiments to form new embodiments.

Various aspects of this disclosure are explained in the following with reference to an LTE (Long Term Evolution) cellular communication system as example for a wireless bidirectional communication system. A mobile terminal used according to aspects of this disclosure may also use other communication systems for communication (possibly using the white space spectrum, if it is available) such as WLAN (wireless local area network), WiFi, UMTS, GSM (Global System for Mobile Communications), Bluetooth etc.

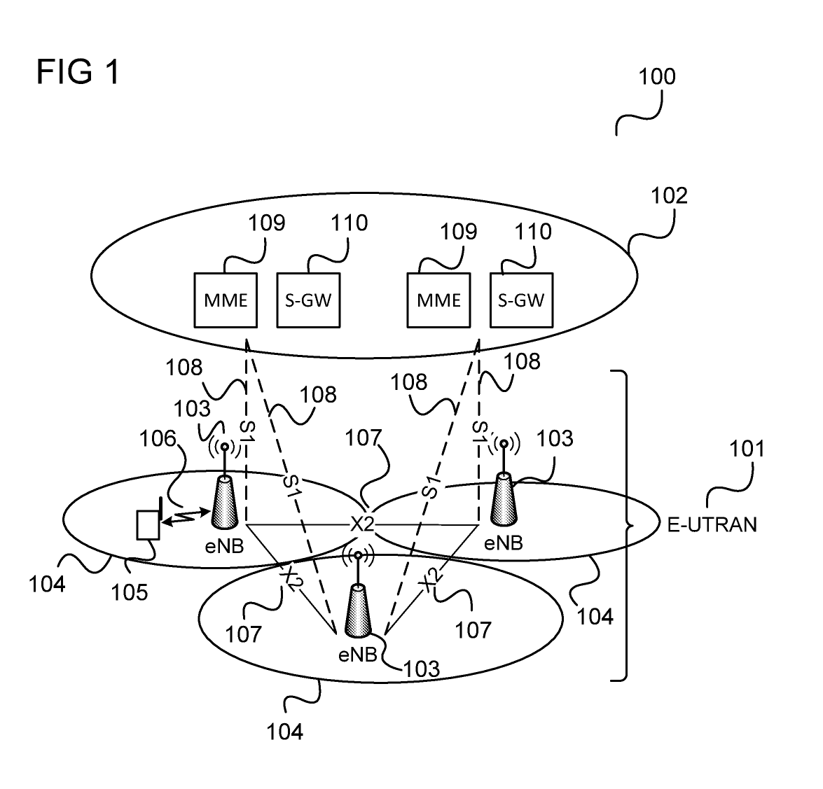

FIG. 1 shows a communication system 100 according to an aspect of this disclosure.

According to this aspect of this disclosure, the communication system 100 is configured in accordance to the network architecture of LTE.

The communication system includes a radio access network (E-UTRAN, Evolved UMTS Terrestrial Radio Access Network) 101 and a core network (EPC, Evolved Packet Core) 102. The E-UTRAN 101 may include base (transceiver) stations (eNodeBs, eNBs) 103. Each base station 103 provides radio coverage for one or more mobile radio cells 104 of the E-UTRAN 101.

A mobile (communication) terminal (UE, user equipment) 105 located in a mobile radio cell 104 may communicate with the core network 102 and with other mobile terminals 105 via the base station providing coverage (in other words operating) the mobile radio cell.

Control and user data are transmitted between a base station 103 and a mobile terminal located in the mobile radio cell 104 operated by the base station 103 over the air interface 106 on the basis of a multiple access method.

The base stations 103 are interconnected with each other by means of the X2 interface 107. The base stations are also connected by means of the S1 interface 108 to the core network (Evolved Packet Core) 102, more specifically to a MME (Mobility Management Entity) 109 and a Serving Gateway (S-GW) 110. The MME 109 is responsible for controlling the mobility of UEs located in the coverage area of E-UTRAN, while the S-GW 110 is responsible for handling the transmission of user data between mobile terminals 105 and core network 102.

The LTE cellular communication network as illustrated in FIG. 1 is designed as a packet switched communication network. In order to support circuit switched services like voice communication between two mobile terminals 105, Voice over IP (VoIP) may be used.

A typical speech coder of a mobile terminal 105 for example produces a speech packet (i.e. a data packet including speech data) every 20 ms. According to LTE, the length of a time transmission interval is 1 ms. Thus, when a mobile terminal 105 transmits speech data, only 1/20^{th} of the time transmission intervals (TTIs) are used for the transmission. Likewise, only 1/20^{th} of the TTIs are used when the mobile terminal 105 receives speech data.

The LTE communication system 100 may be a power optimized with regard to speech data transmission by making use of the periodic generation of speech packets in that the corresponding base station 103 periodically reserves uplink and downlink radio resources for the voice packets. For example, when the communication system uses FDD (frequency division duplexing), the base station 105 may align the uplink communication resources for the transmission of an uplink packet with the transmission of the ACK (acknowledgement) or NAK (negative acknowledgement) for a downlink packet to reduce the use of scarce uplink communication resources and to allow for power savings on the mobile terminal side. In case that TDD (time division duplexing) is used, uplink packet transmission time intervals and downlink packet transmission time intervals are fit into the TDD schedule.

If the transmission schedule has a misaligned phase offset compared to the arrival of a speech (e.g. VoIP) packets at the transmitter (e.g. from a speech coder), the speech packet is buffered to be transmitted for the next allocated TTI. This may lead to speech packet being delayed up to 20 ms depending on their time of arrival in the transmitter (specifically, for example the MAC (medium access control) layer) compared to the ideal case. This may happen in both for both uplink transmission as well as downlink transmission, i.e. both on the mobile terminal side as well as on the network side. In worst case, this can increase the round trip latency by 40 ms and, if the transmission is between two mobile terminals 105, by up to 80 ms.

According to one aspect of this disclosure, speech packet generation is synchronized with a predefined transmission schedule, e.g. of the cellular mobile communication network. In other words, according to one aspect of this disclosure, a mechanism is provided to align the generation of speech packets with the transmission schedule of a cellular mobile communication network. If packets are generated with the same periodicity as subframes (or generally transmission periods) are allocated for transmitting the packets, this can be seen as aligning the phases of the packet generation and the pattern of allocated transmission periods. This for example includes usage of an interface via which the buffer duration of a packet in the MAC layer (i.e. the time in which the packet stays in the MAC layer until it is sent) is reported such that adjustments to the time of packet generation and delivery to the MAC layer can be made (the delivery to the MAC layer may include processing of intermediate components between the speech coder and the MAC layer such as RTP encoding, IP encoding etc. in case that the packet is a higher layer packet such as a speech data frame; alternatively, the generated packet can itself be a MAC PDU depending on which components are seen as being part of the speech encoder such that the delivery to the MAC layer merely comprises supplying the packet to the MAC layer). Such a mechanism can not only be applied to speech packets but also to other data packets, e.g. generally to media data packets which include data of a real-time media data stream (e.g. a video conference) such that low latency is desirable.

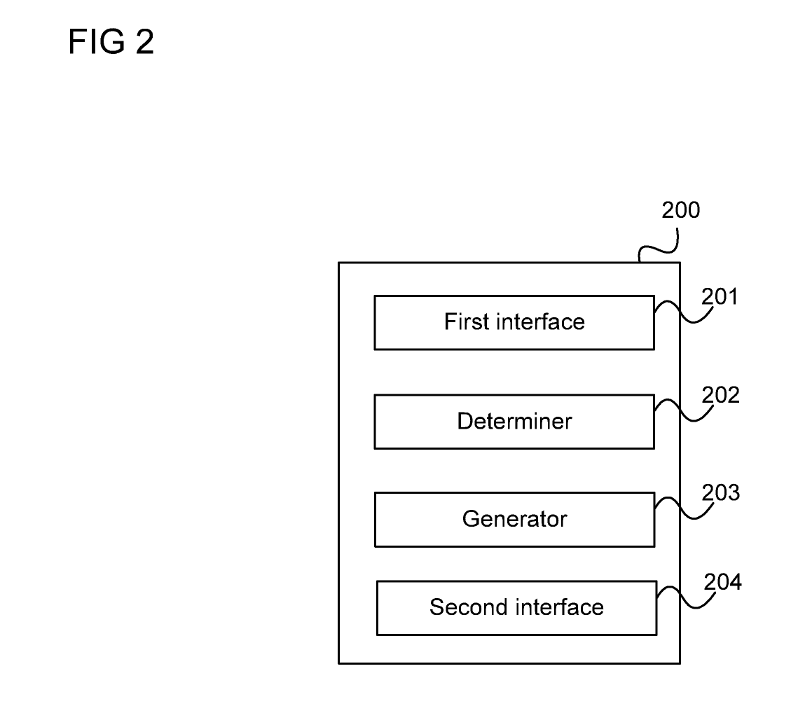

A communication device which may be seen to provide such a mechanism is illustrated in FIG. 2.

FIG. 2 shows a communication device 200.

The communication device includes a first interface 201 configured to receive a first packet supplied by a packet encoder and a determiner 202 configured to determine a time difference between the time at which the first packet is ready to be sent by the communication device and a time at which communication resources for sending the first packet are available.

The communication device 200 further includes a generator 203 configured to generate information from which it is derivable when a second packet should be provided by the packet encoder based on the time difference and a second interface 204 configured to transmit the information to the packet encoder.

According to one aspect of this disclosure, in other words, it is determined how long a data packet has to wait after being delivered by a packet encoder until it can be sent, i.e. until there are communication resources available (e.g. allocated) for sending the data packet. Information about this waiting time (e.g. an indication of the waiting time) is fed back to the packet encoder such that the packet encoder can accordingly adjust the time of delivery of another data packet (e.g. following data packets) such that the waiting time for the other data packet is reduced. In other words, information for allowing a retiming of the packet generation, in terms of adapting it to the transmission schedule, is fed back to the packet generator (or packet encoder). The packet encoder may include a plurality of components of different layers such as a media encoder (e.g. speech encoder) generating the media frames (e.g. speech frames), an RTP (Real-time Transfer Protocol) encoder, an IP (IP protocol) encoder, a PDCP (Packet Data Convergence Protocol) encoder and a RLC (Radio Link Control) encoder. Accordingly the first packet and the second packet may be packets of various layers. For example, the first packet and the second packet are data link layer PDUs (packet data units) or more specifically MAC (medium access control) PDUs (packet data units). The time at which the first packet is ready to be sent by the communication device is in this case for example the time at which the first packet is available in the data link layer (or MAC layer) for being passed to the physical layer for sending, i.e. when all necessary processing for transmitting the first packet to be carried out by any higher layer than the data link layer has been completed and the first packet has been supplied to and is being buffered in the data link layer (or MAC layer).

The time at which the first packet is ready to be sent may thus be the time when at most some processing of the data link layer (or of the MAC layer) remains before sending, e.g. inserting the first packet into a transport block etc.

The feedback signal, i.e. the information about the waiting time of the data packet that is fed back to the packet encoder, may be processed by a low pass filter before being provided to the packet encoder, such that, for example, brief fluctuations of the waiting time are filtered out.

It should be noted that the first data packet and the second data packet may also be higher layer packets, e.g. RTP packets. In this case, the packet encoder for example includes a media coder (e.g. a speech coder) and an RTP coder, e.g. in case that the packet encoder is not part of the communication device and transmits the first packet and the second packet to the communication device in form of RTP packets. The time at which the first packet is ready to be sent may in this case also be the time at which the further processing of the RTP packet (e.g. IP encoding, PDCP encoding, RLC encoding, etc. which may be seen to be part of the delivery of the packet to the data link layer or MAC layer) has been completed and it is available in the data link layer (or the MAC layer) to be passed to the physical layer to be sending. The time at which the first packet is ready to be sent may in this case however also be the time at which the RTP packet is available in the communication device and all that remains to be done before sending is the processing of the lower layers (i.e. below the RTP encoding).

The components of the communication device (e.g. the interfaces, the determiner and the generator) may be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit”.

For example, the following components may be involved according to one aspect of this disclosure:

A measurement circuit (e.g. corresponding to the determiner 202) which measures the time between the arrival of a packet in a transmit queue of the MAC layer (e.g. corresponding to the MAC layer of a transmitter of the communication device, such as a radio transceiver) and the departure of that packet when the packet is forwarded to the physical layer (e.g. of the transmitter of the communication device) for transmission.

A feedback channel to the speech coder (e.g. corresponding to the second interface 203) which relays the time difference information from the measurement circuit to the packet encoder that has supplied the packet. The feedback channel for example includes an interface at the MAC layer for reporting the time difference observed by the measurement circuit.

Means of the packet encoder (e.g. a speech coder) which aligns its phase of speech packet generation such that the time in the transmit queue of future packets is reduced (e.g. minimized).

Thus, according to one aspect of this disclosure the retention of a data packet in a MAC queue is measured or monitored and corresponding information is fed back to the speech coder (or generally the packet encoder or the entity supplying the data packets), e.g. from the cellular MAC layer to the packet encoder. The packet encoder adjusts its phase of packet generation.

It should be noted that the packet encoder may be part of the communication device (e.g. in case the communication device is a communication terminal) or may not be part of the communication device (e.g. in case the communication device is a base station). Accordingly, the first interface and the second interface may be internal interfaces of the communication device or interfaces to another communication device.

The communication device may further include a buffer configured to store the received first packet, wherein the time difference is determined based on the buffer time of the first packet.

The first packet and the second packet are for example packets of a sequence of packets and the second packet is for example a subsequent packet of the first packet (e.g. the packet directly following the first packet in the sequence of packets).

The first packet and the second packet for example include data of a media data stream.

The media data stream is for example a real-time communication stream.

The first packet is for example generated in accordance with a packet generation timing pattern and it is for example derivable from the information how the packet generation timing pattern is to be adjusted for the generation of the second packet.

The first packet may be generated in accordance with a packet generation timing pattern and it is for example derivable from the information how much the generation of the second packet should be delayed or advanced with respect to the scheduled time of generation of the second data packet as given by the packet generation timing pattern.

According to one aspect of this disclosure, the communication device includes the packet encoder, wherein the packet encoder is configured to generate the first packet and the second packet.

The packet encoder is for example configured to generate the first packet and the second packet from a media stream. The media stream is for example a data stream of video data or audio (e.g. speech) data.

According to one aspect of this disclosure, the first packet and the second packet are consecutive packets in a sequence of packets, wherein the packet encoder is configured to encode the media stream into the sequence of packets, and wherein the packet encoder is configured to omit a part of the media stream in the encoding wherein the omitted part corresponds to a delay of the time of generation of the second data packet derived from the information.

According to one aspect of this disclosure, the first packet and the second packet are consecutive packets in a sequence of packets, wherein the packet encoder is configured to encode the media stream into the sequence of packets, and wherein the packet encoder is configured to compress a part of the media stream in the encoding such that the duration of the part of the media stream is reduced by an amount of time corresponding to a delay of the time of generation of the second data packet derived from the information.

The communication device is for example a mobile terminal.

The first packet and the second packet are for example data link layer PDUs.

For example, the first packet and the second packet are MAC PDUs.

According to one aspect of this disclosure, the communication device is a base station.

The base station is configured to receive the first packet and the second packet from another communication device which includes the packet encoder (e.g. a media gateway).

For example in this case, the first packet and the second packet are RTP packets.

The time at which communication resources for sending the first packet are available is for example the time for which communication resources are allocated to the communication device for sending the first packet.

The time at which communication resources for sending the first packet are available is for example the time for which communication resources are allocated to the communication device for sending the first packet by a communication network.

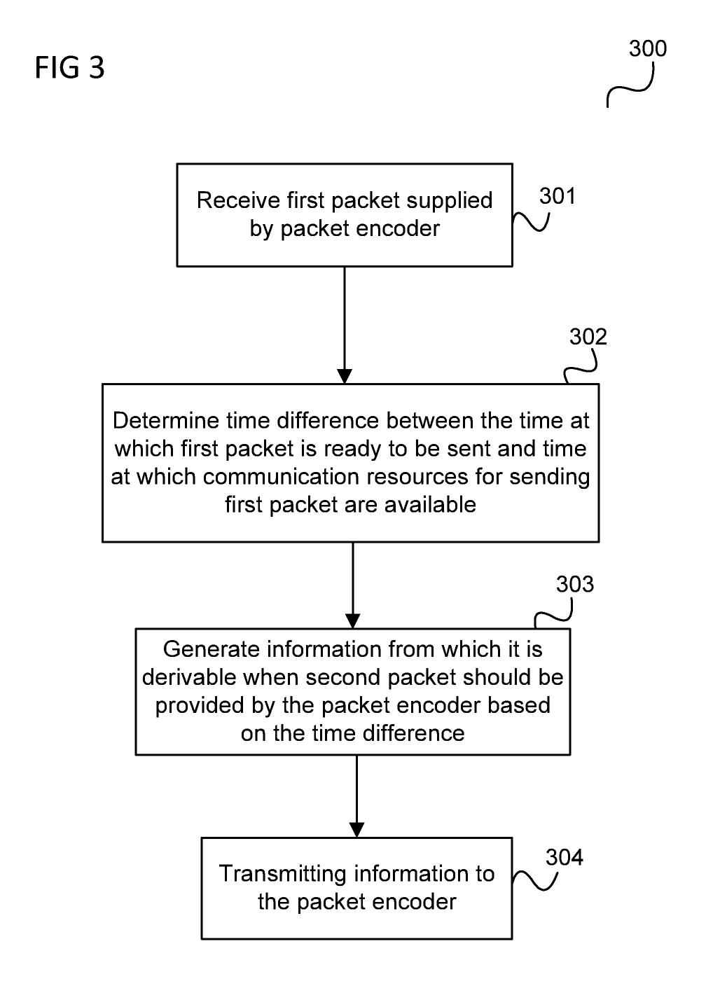

The communication device for example carries out a method as illustrated in FIG. 3.

FIG. 3 shows a flow diagram 300.

The flow diagram 300 illustrates a method for controlling packet generation.

In 301 a first packet supplied by a packet encoder is received.

In 302, a time difference between the time at which the first packet is ready to be sent and a time at which communication resources for sending the first packet are available is determined.

In 303, information is generated from which it is derivable when a second packet should be provided by the packet encoder based on the time difference.

In 304, the information is transmitted to the packet encoder.

It should be noted that aspects described in context of the communication device 200 are analogously valid for the method illustrated in FIG. 3 and vice versa.

In the following, aspects of this disclosure are described in more detail in context of the LTE communication system 100 as an exemplary underlying architecture.

LTE has been designed to address the need for mobile Internet access. Internet traffic can be characterized by its high burstiness with high peak data rates and long silence periods. According to one aspect of this disclosure, in accordance with LTE, in order to allow for battery savings of the mobile terminal 105, the communication system 100 supports DRX (discontinuous reception). According to LTE, two DRX periods are supported. These are referred to as short DRX and long DRX, respectively. According to LTE, for the reverse link, i.e. uplink direction (from mobile terminal 105 to base station 103), in order to increase system capacity, the communication system 100 supports DTX (discontinuous transmission). For uplink traffic, the mobile terminal 105 reports its uplink buffer status to the base station 103 which then schedules and assigns uplink communication resources, specifically resource blocks (RBs), to the mobile terminal 105.

In the following, it is assumed that the mobile terminal 105 has a speech connection (specifically a Voice over LTE (VoLTE) connection in this example, or more generally a VoIP connection), e.g. to another mobile terminal which may use the same communication network or another communication network connected to the communication network. The VoLTE connection uses a communication connection between the mobile terminal 105 and the base station 103 to exchange data between the mobile terminal 105 and the network side.

The VoLTE connection is known to the base station 103. Typically, the network side (i.e. the E-UTRAN 101) tries to reduce the required active periods for the mobile terminal 105, e.g. for one or more of the following reasons:
Allow maximum power savings for the mobile terminal 105;
Reduce signaling overhead in the network (e.g. the E-UTRAN 101).

The LTE standard provides several means for reducing the required active periods. For example, for the speech connection, the E-UTRAN 101 may use DRX to save power of the mobile terminal 105. This can be done with or without semi-persistent scheduling (SPS).

SPS announced by the base station 103 is one means that has been included in the LTE communication standard for reducing signaling overhead for isochronous traffic. When setting up the VoIP connection with dedicated bearer for conversational Voice QCI (Quality of Service Class Identifier) value set to one, it can be assumed by the base station 103 that the mobile terminal 105 will by default need to transmit one VoIP packet every 20 ms and need to receive one VoIP packet every 20 ms, respectively. Using SPS, the base station 103 can in advance schedule uplink and downlink subframes for data transmission. In combination with DRX, when configured, the mobile terminal 105 is then not required to listen to each subframe. Instead, the mobile terminal 105 only needs to receive a subframe according to the DRX period and the SPS schedule. Extra signaling in the PDCCH (Packet Data Control Channel) is not needed, as the allocation is already agreed between the mobile terminal 105 and the base station 103 during SPS setup. For lowest active times, the base station 103 may configure the implicit UL grants in the same receive periods for the DL data. The UL grant points to a subframe that is four TTIs (transmission time intervals, i.e. subframes) later. This schedule allows the mobile terminal to transmit an ACK (acknowledgement) of a received packet together with an UL data packet in the PUSCH (Physical Uplink Shared Channel). This way, the mobile terminal 105 needs to transmit only during one subframe every SPS period.

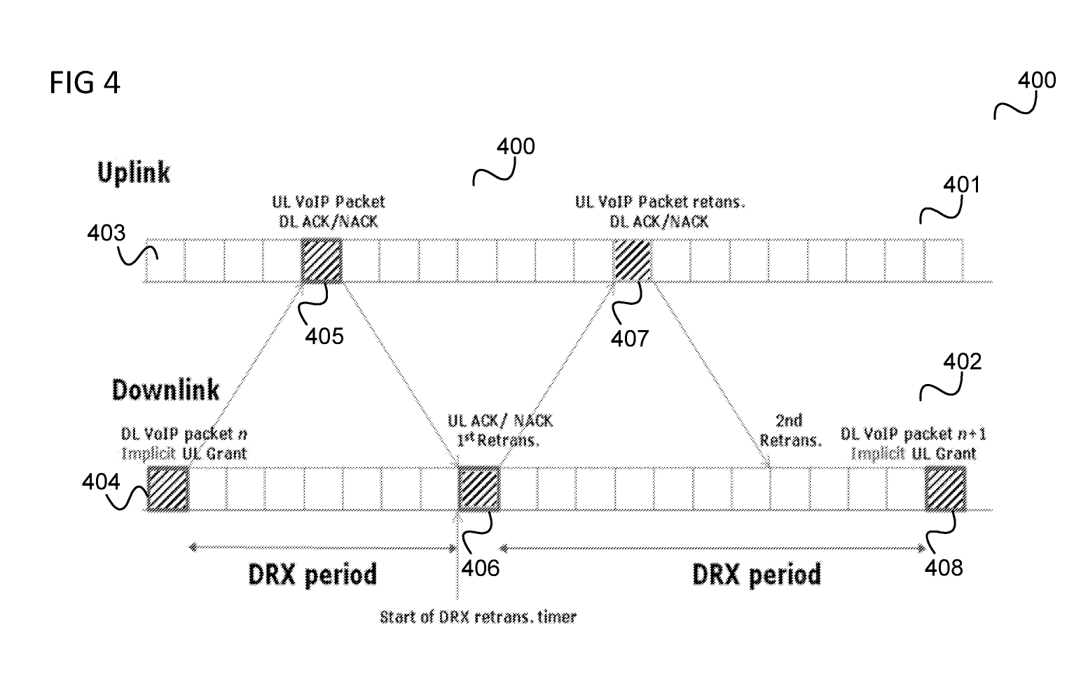

The transmission of speech packets between the mobile terminal 105 and the base station 103 according to one aspect of this disclosure is illustrated in FIG. 4.

FIG. 4 shows a transmission diagram 400.

The transmission diagram 400 illustrates the SPS and DRX schedule for VoLTE for 20 ms DRX periods. It includes a first sequence of subframes 401 illustrating uplink transmissions between the mobile terminal 105 and the base station 103 and a second sequence of subframes 402 illustrating downlink transmissions between the mobile terminal 105 and the base station 103. It is assumed that subframes which are horizontally at the same position correspond to the same period of time.

In the transmission diagram 400, a rectangle 403 indicates a subframe of 1 ms duration, where 1 ms is the length of a time transmission interval (TTI). There are 20 subframes within a DRX period. A hatched rectangle denotes transmission or reception of information depending on whether it indicates a subframe of the first sequence of subframes 401 (corresponding to uplink, i.e. transmission from the point of view of the mobile terminal 105) or of the second sequence of subframes 402 (corresponding to downlink, i.e. reception from the point of view of the mobile terminal 105).

A VoIP packet needs to be received every 20 ms. In a first subframe 404, the mobile terminal 105 receives the nth downlink VoIP packet in course of the VoIP connection. The transmission of the next uplink packet is scheduled four TTIs after the first subframe 404 for a second subframe 405 such that the ACK/NACK information can be sent along with the uplink packet in the second subframe 405. Thus, the SPS uplink grant is implicitly scheduled with the downlink packet. The uplink ACK/NACK information is expected four TTIs after the second subframe 405 in a third subframe 406.

At the start of the third subframe 406, the mobile terminal 105 starts the DRX retransmission timer. In an optimized network, the base station 103 sends the ACK/NACK information indeed after four TTIs in the third subframe 406 in order to allow the mobile terminal 105 to go to sleep as early as possible.

In case of a NACK, the mobile terminal 105 retransmits the uplink data packet in a fourth subframe 407. The typical case, however, is the case where the uplink packet has been received correctly, and the mobile terminal 105 is allowed to go to sleep, immediately thereafter. The mobile terminal 105 can then sleep until a fifth subframe 408, which is the next SPS subframe, in which it receives the n+1st VoIP packet.

Thus, in an optimized network using SPS, the mobile terminal 105 needs to receive two subframes out of 20 (for 20 ms voice packet transmission intervals) and needs to transmit one subframe during the 20 ms period.

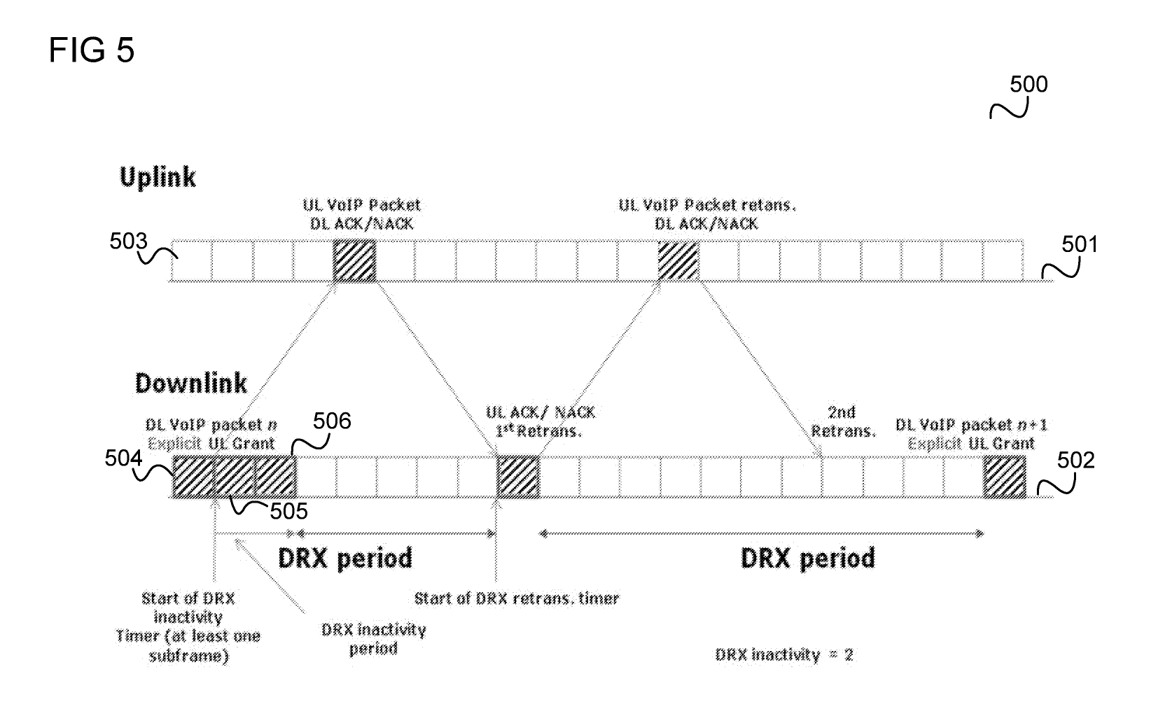

Without SPS, the base station 103 may use a similar UL/DL transmission schedule which is illustrated in FIG. 5.

FIG. 5 shows a transmission diagram 500.

The transmission diagram 500 illustrates the schedule for VoLTE for 20 ms DRX period without SPS.

It includes a first sequence of subframes 501 illustrating uplink transmissions between the mobile terminal 105 and the base station 103 and a second sequence of subframes 502 illustrating downlink transmissions between the mobile terminal 105 and the base station 103. It is assumed that subframes which are horizontally at the same position correspond to the same period of time.

As in FIG. 4, a rectangle 503 indicates a subframe of 1 ms duration in the transmission diagram 500, where 1 ms is the length of a time transmission interval (TTI). There are 20 subframes within a DRX period. A hatched rectangle denotes a sub-frame in which the mobile terminal 105 transmits or has to receive a channel depending on whether the rectangle indicates a subframe of the first sequence of subframes 501 (corresponding to uplink, i.e. transmission from the point of view of the mobile terminal 105) or of the second sequence of subframes 502 (corresponding to downlink, i.e. reception from the point of view of the mobile terminal 105).

In this example, with the DRX cycle, the mobile terminal 105 wakes up to listen to the PDCCH in which the base station 103 signals that the PDSCH includes data (i.e. downlink packets) for the mobile terminal 105. The mobile terminal 105 receives the PDSCH and receives, in a first sub-frame 504, the transport block(s) containing the nth downlink VoIP packet. In the PDCCH, the base station 103 also signals explicitly the uplink grant to the mobile terminal 105 in a second sub-frame 505 and a third sub-frame 506. Without SPS the mobile terminal 105 is not allowed to sleep right afterwards. Instead, the mobile terminal 105 sets its DRX inactivity timer and continues listening to the following subframes. The number of subframes to observe after the reception of a PDSCH is defined by the eNB as the DRX inactivity period. The DRX inactivity period is common for all mobile terminals in the entire radio cell 104. According to 3GPP Release 8 and 9 the minimum length of the DRX inactivity period is one sub-frame, i.e., the UE has to receive at least one more subframe than for an SPS schedule. In FIG. 5 a DRX inactivity period length of 2 (i.e. two sub-frames) is assumed and accordingly has to keep its receiver active in a second sub-frame 505 and a third sub-frame 506. The rest of the transmission flow is similar to the one explained with reference to FIG. 4.

According to 3GPP Release 8, the mobile terminal 105 tries to send a Buffer Status Report (BSR) over PUCCH to the base station 103 once a MAC PDU (Packet Data Unit) has been generated for an IP (Internet Protocol) encapsulated voice encoder packet. Once the status report has been sent the mobile terminal 105 listens to the corresponding downlink PDCCH in the subframe four TTIs later and for all subframes thereafter until the uplink grant is received. This behavior typically impacts the power consumption of the mobile terminal 105 for the following reasons:
The mobile terminal 105 sends additional BSRs using PUCCH
If the base station 103 immediately responds, uplink and downlink are likely to be unaligned and ACK/NACK information cannot be assumed to be transmitted along with PUSCH.
If the base station 103 does not immediately respond, the mobile terminal cannot put the Layer 1 including the transmitter (TRX) asleep.
   With 3GPP Release 9, the so called SR prohibit timer is introduced that defers the transmission of an SR and avoids SR retransmissions. Using the SR prohibit timer, the schedule illustrated in FIG. 4 can be achieved.

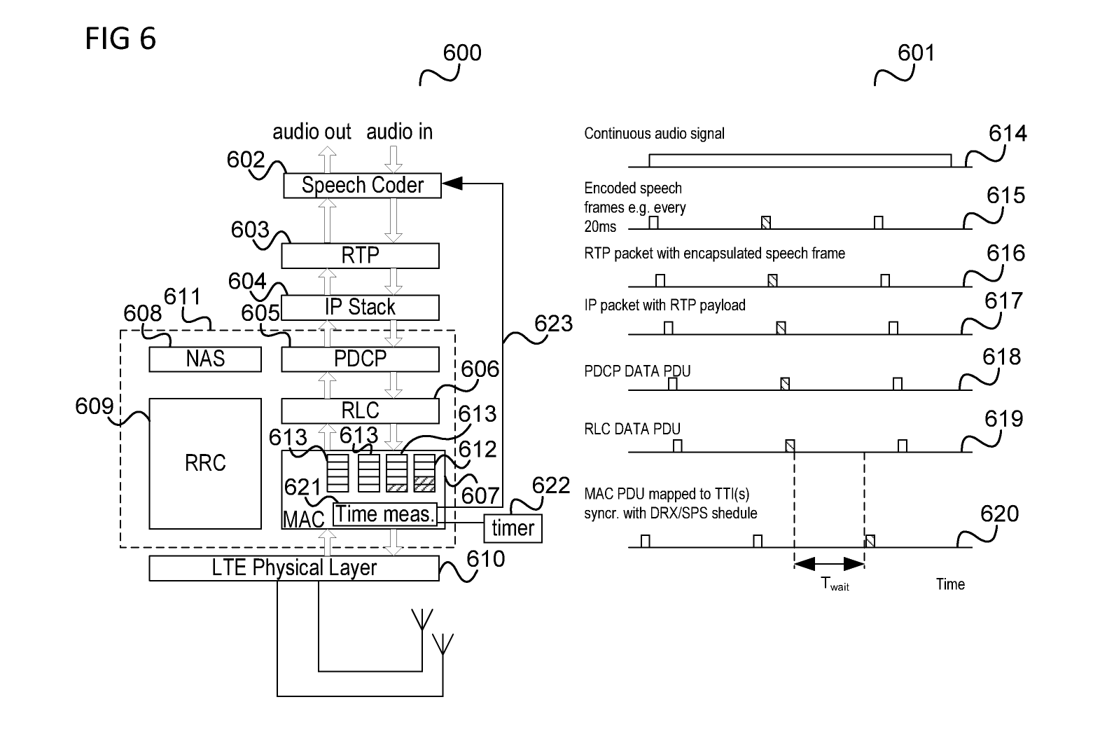

The transmission scheme described with reference to FIG. 4 can be seen to exploit the periodicity of the speech coder and allocates communication resources with the same periodicity. It can be seen that latency in the transmission is smaller if the alignment between the speech packet generation (i.e. the speech packets being ready to send) with the time at which communication resources are allocated for the transmission is better, in other words, if the phase difference between the (periodic) packet generation and the (periodic) allocation of communication resources for packet transmission is smaller. The operation of a communication terminal according to one aspect of this disclosure in an VoLTE context which supports reduction of this phase difference is described in the following with reference to FIG. 6.

FIG. 6 shows a data flow diagram 600 and a timing diagram 601.

The data flow takes place between components of a communication terminal for example corresponding to the mobile terminal 105. Specifically, the data flow takes place between a speech coder 602, an RTP packet coder 603, an IP packet coder 604, a PDCP coder 605, a RLC (radio link control) coder 606, a MAC layer 607 and an LTE physical layer 610. The PDCP coder 605, the RLC coder 606 and the MAC layer are part of the LTE protocol stack 611, e.g. implemented by an LTE modem, which may further include NAS (Non-Access Stratum) components 608 and RRC components 609.

The coders 602, 603, 604, 605 and 606 may operate both as encoders and as decoders depending on whether speech data is transmitted or received by the communication terminal.

In case that the communication terminal transmits speech data, the speech coder 602 takes audio/voice samples at its input and encodes them. The encoded voice samples are packetized using the real time transfer protocol (RTP) by the RTP coder 603 and then IP encapsulated by the IP coder 604. The IP packets are then forwarded to the LTE modem (i.e. LTE protocol stack 611). After PDCP encoding by the PDCP coder 605 and RLC packetizing by the RLC coder 606, the MAC protocol data units (PDUs) arrive in the MAC layer 607 of the LTE protocol stack 611.

In this example, it is assumed that the VoLTE connection is allocated its own radio bearer. Therefore, VoLTE related MAC PDUs arrive in one dedicated MAC queue 612 of a plurality of MAC queues 612, 613 in the MAC layer 607. The retention time for a packet (i.e. a packet data unit) in the queue depends on when the MAC scheduler schedules the transmission of the packet. Since the base station 103 knows about the periodic packet generation of a speech coder it grants a resource to the VoLTE connection with the same periodicity as the one of the speech packet generation.

It is assumed that the MAC scheduler in the base station 103 has an isolated view and either schedules uplink resources depending on the buffer status of the different MAC queues 612, 613 of the MAC layer 607 or, in case the isochronous profile of a connection is known, periodically.

The mobile terminal 105 is notified by the base station 103 either explicitly through an uplink grant or implicitly through an SPS about an available uplink resource (i.e. a communication resource allocated for uplink transmission by the mobile terminal 105). The MAC layer 607 then generates a transport block containing the uplink data. If all MAC queues 612, 613 happen to be empty, the MAC layer 607 inserts empty packets into the transport block. The transport block is then transmitted by the mobile terminal 105 to the base station 103.

The timing diagram 601 illustrates the timing relationship of a packet generated by the speech coder 602 passing the different interfaces between the components 602 to 607 and finally to the physical layer 610. Specifically, along a first time axis 614, the timing of the continuous audio signal input from an upper layer, e.g. an application to the speech coder 602 is shown. Along a second time axis 615, the timing of the encoded speech frames supplied by the speech coder 602 to the RTP coder 603 is shown. In this example, the speech coder frame period is 20 ms. Along a third time axis 616, the timing of the RTP packets generated by the RTP encoder 603 is shown. Along a fourth time axis 617, the IP packets with the RTP payload generated by the IP coder 604 is shown. Along a fifth time axis 618, the PDCP data PDUs generated by the PDCP coder 605 is shown. Along a sixth time axis 619, the timing of the MAC PDUs generated by the RLC coder 606 and supplied to the MAC layer 607 is shown. Along a seventh time axis 620, the timing of the TTIs used for sending the RLC data PDUs is shown. It is assumed that points on the time axes 614 to 620 that are horizontally at the same position correspond to the same points in time.

It can be seen that, although the MAC layer schedules transmission intervals with the same periodicity as the speech frame generation, a considerable amount of time indicated as T_{wait} in FIG. 6 is spent in the MAC queue 612 by the RLC data PDUs if the speech coder 612 is not appropriately aligned with the transmission schedule.

Therefore, according to one aspect of this disclosure, a measurement circuit 621 is implemented in the MAC layer 607. The measurement circuit 612 measures the retention time of a speech coder packet. More precisely the measurement circuit 621 measures the retention time of a MAC PDU (e.g. an RLC data PDU) in the queue 612 related to the radio bearer that is used for the voice over LTE speech frame transmission. In order to measure this time the measurement circuit 612 may be connected to a timer 622 of the mobile terminal 105 which provides, for example, a clock signal.

The measurement circuit 621 sends an indication of the retention period, T_{wait} to the speech coder 602, for example via a specific signaling interface 623.

Based on the indicated retention period, the speech coder 602 adjusts its packet generation such that the time T_{wait} is minimized (for future speech packets).

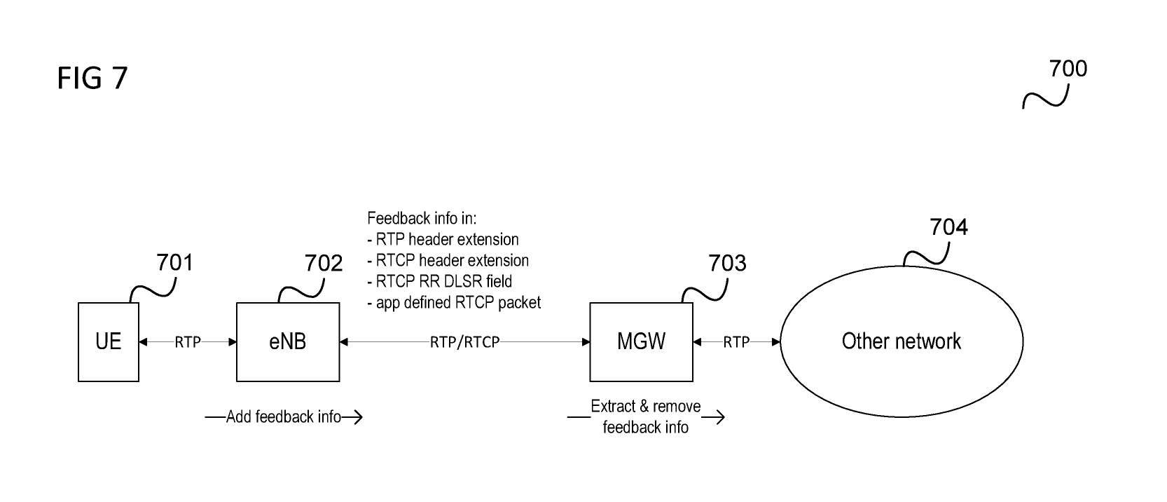

The concept of measuring a retention time and correspondingly adapting speech packet (or generally media data packet) generation may also be applied to the network side. This is described in the following with reference to FIG. 7.

FIG. 7 shows a communication arrangement 700.

The communication arrangement 700 includes a mobile terminal 701, for example corresponding to mobile terminal 105, a base station 702, for example corresponding to base station 105, a media gateway (MGW) 703, for example arranged in the core network 102, and another network (e.g. another core network of another cellular mobile communication system or the Internet).

In this example, it is assumed that a speech coder resides in the media gateway 703.

The media gateway 703 receives RTP packets from the other network 704 and generates RTP packets on its own and sends them to the base station 702. The base station 702 forwards the RTP packets to the mobile terminal 701.

The base station 702 sends feedback information to the speech coder in the media gateway 703 via a control channel.

The feedback information may include an indication of the time difference between receiving an RTP packet from the MGW 703 (by the base station 702) and transmitting the buffered packet to the mobile terminal 701 via the air interface. The time difference may be indicated with a resolution of 1 ms and is for example binary encoded. This would require 5 bits for feedback information.

The control channel can be based on RTP/RTCP. In order to include the feedback information in RTP/RTCP packets the base station 702 and the media gateway 703 may act as RTP/RTCP translators according to the RTP. The base station 702 modifies RTP/RTCP packets to be sent from the mobile terminal 701 to the media gateway 703 by inserting header extensions either in RTP packets (e.g. uplink speech RTP packets in case of two-way VoIP connection) or in RTCP packets. The header extensions include the feedback information.

If RTCP packets are being used for the feedback information and no RTCP packets are being transmitted from the mobile terminal 701 to the MGW 703 (as in active VoLTE calls) then the RTP/RTCP translator of the base station 702 generates RTCP packets for transmitting the feedback information to the MGW 703. The RTP/RTCP translator of the MGW 703 discards the received RTCP packets after extracting the feedback information (i.e. it does not forward the RTCP packets to the RTP sender).

Alternatively the time difference may not be indicated by a header extension but by the DLSR (Delay Since Last Sender Report) field of an RTCP receiver report sent by the base station 702 to the MGW 703. In this case the receiver report may be sent when the buffered RTP packet is transmitted via the air interface to the mobile terminal 701 by the base station 702. The DLSR field indicates the delay by the base station 702 since the last sender report. Therefore it indicates the RTP packet's buffer time.

Another alternative is to use application defined RTCP packets for transmitting the feedback information.

Before using the feedback channel the MGW 703 may inform the base station 702 that the MGW 703 supports the feedback channel. If the MGW 703 does not support the feedback channel then the 702 does not need to send feedback information. Informing on feedback support can for example be done via RTP/RTCP header extensions or via application defined RTCP packets or via other means.

Alternatively the MGW 703 may not inform the 702 on feedback support by the MGW 703. In this case the base station 702 can send feedback via RTP/RTCP header extensions or via application defined RTCP packets to the MGW 703. If the MGW 703 does not support the feedback then (according to RTP) the MGW 703 just ignores the received header extensions or application defined RTCP packets.

The IP port used by the base station 702 and the MGW 703 for conveying RTP/RTCP packets can be re-used from the ongoing VoIP session (if applicable) or agreed during dedicated bearer setup between the base station 702 and the MGW 703.

After having received the feedback information from the base station 702 the MGW 703 adjusts the timing of speech packets such that the buffer time of the (future) RTP packets in the base station 702 is minimized (or at least reduced).

For the adjusting, a re-timing of the speech data is performed. For this, a re-distribution of parts (i.e. segments) of the audio (speech) signal stream on RTP packets is performed. This means that the speech data included in the RTP packets transmitted from the other network 704 to the media gateway 703 is extracted from the RTP packets and new RTP packets are generated including the speech data to be sent to the base station 702, wherein, depending on the feedback information, the distribution of parts of the audio stream to RTP packets is changed such that in the end, the timing of the RTP packets is changed. This process may be referred to as re-encoding or recoding. The recoding process requires little effort and can thus be carried out quickly. However, multiple RTP packets need to be fully received from the other network before the included speech data may be recoded which may lead to delay (and thus increase latency of the VoLTE connection).However, this latency may by reduced by transmitting the RTP packets from the other network 704 with high frequency (i.e. with little time between two consecutive RTP packets), i.e. by including only a short segment of the audio stream in each RTP. On the network side, overall latency can thus be mainly reduced if the frequency of the transmission of the RTP packets from the other network 704 is higher than the frequency of transmission of the RTP packets from the media gateway 703 to the base station 702.

Both on the network as well as on the mobile terminal side, re-timing of speech packets can be done simply by omitting or repeating speech signal segments.

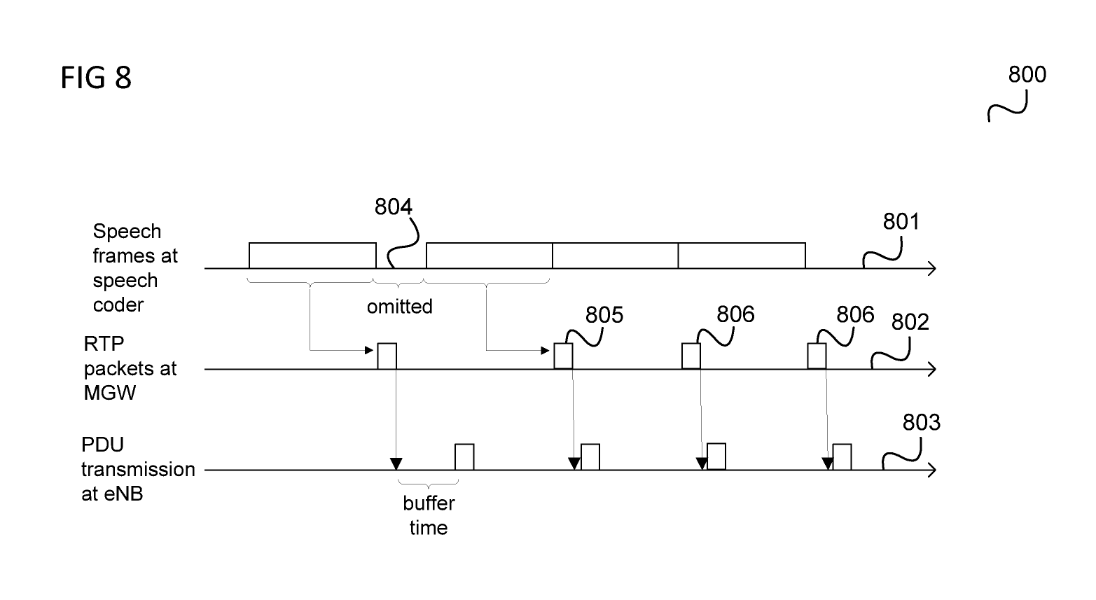

FIG. 8 shows a timing diagram 800 illustrating omitting speech signal segments for speech packet re-timing.

The timing diagram 800 illustrates the timing relationship of a packet in case of the network side when speech signal segments are omitted for re-timing of RTP packets. This may be analogously applied at the mobile terminal side.

Along a first time axis 801 the timing of the speech data as received by the speech coder of the MGW 703 (e.g. already extracted from the received RTP packets). Along a second time axis 802 the timing of the RTP packets generated by the MGW 703 (by re-coding) is shown. Along a third time axis 803 the timing of the transmission of the RTP packets by the base station 702 to the mobile terminal 701 is shown. It is assumed that points on the time axes 801 to 803 that are horizontally at the same position correspond to the same points in time.

As can be seen, in this example, the media gateway 703 omits an audio segment 804 in the re-coding such that the resulting RTP packet 805 (and all following RTP packets 806) have a timing which is closer to the timing of the allocated resources as illustrated in the time axis 803 such that the buffer time in the base station 702 is reduced.

With this approach, however, the speech signal received at the mobile terminal 105 is not continuous which may result in disturbed speech perception.

Disturbed speech perception can be avoided when re-timing the speech signals by expanding or compressing speech segments in time (i.e. slowing down or accelerating the speech signal for some time). Speech expansion and compression can also be applied on the mobile terminal side for adjusting the timing of speech packets from the mobile terminal 105 to the base station 103.

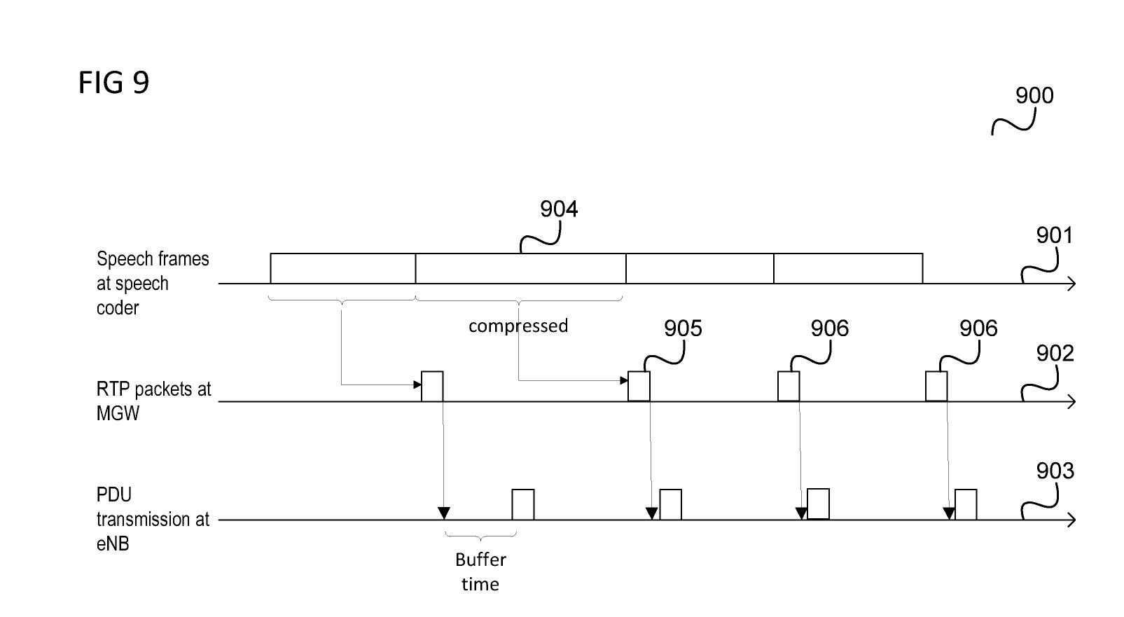

FIG. 9 shows a timing diagram 900 illustrating compressing speech signal segments for speech packet re-timing.

The timing diagram 900 illustrates the timing relationship of a packet in case of the network side when speech signal segments are compressed for re-timing of RTP packets. This may be analogously applied at the mobile terminal side.

Along a first time axis 901 the timing of the encoded speech frames as received by the MGW 703 is shown. Along a second time axis 902 the timing of the RTP packets generated by the MGW 703 (by re-coding) is shown. Along a third time axis 903 the timing of the transmission of the RTP packets by the base station 702 to the mobile terminal 701 is shown. It is assumed that points on the time axes 901 to 903 that are horizontally at the same position correspond to the same points in time.

As can be seen, in this example, the media gateway 703 compresses an audio segment 904 in the re-coding such that the resulting RTP packet 905 (and all following RTP packets 906) have a timing which is closer to the timing of the allocated resources as illustrated in the time axis 903 such that the buffer time in the base station 702 is reduced.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A communication device comprising
a first interface configured to receive a first packet supplied by a packet encoder;
a determiner configured to determine a time difference between the time at which the first packet is ready to be sent by the communication device and a time at which communication resources for sending the first packet are available;
a generator configured to generate information from which it is derivable when a second packet should be provided by the packet encoder based on the time difference;
a second interface configured to transmit the information to the packet encoder.

2. The communication device of claim 1, further comprising a buffer configured to store the received first packet, wherein the time difference is determined based on the buffer time of the first packet.

3. The communication device of claim 1, wherein the first packet and the second packet are packets of a sequence of packets and the second packet is a subsequent packet of the first packet.

4. The communication device of claim 1, wherein the first packet and the second packet comprise data of a media data stream.

5. The communication device of claim 4, wherein the media data stream is a real-time communication stream.

6. The communication device of claim 1, wherein the first packet is generated in accordance with a packet generation timing pattern and it is derivable from the information how the packet generation timing pattern is to be adjusted for the generation of the second packet.

7. The communication device of claim 1, wherein the first packet is generated in accordance with a packet generation timing pattern and it is derivable from the information how much the generation of the second packet should be delayed or advanced with respect to the scheduled time of generation of the second data packet as given by the packet generation timing pattern.

8. The communication device of claim 1, further comprising the packet encoder, wherein the packet encoder is configured to generate the first packet and the second packet.

9. The communication device of claim 8, wherein the packet encoder is configured to generate the first packet and the second packet from a media stream.

10. The communication device of claim 8, wherein the first packet and the second packet are consecutive packets in a sequence of packets, wherein the packet encoder is configured to encode the media stream into the sequence of packets, and wherein the packet encoder is configured to omit a part of the media stream in the encoding wherein the omitted part corresponds to a delay of the time of generation of the second data packet derived from the information.

11. The communication device of claim 8, wherein the first packet and the second packet are consecutive packets in a sequence of packets, wherein the packet encoder is configured to encode the media stream into the sequence of packets, and wherein the packet encoder is configured to compress a part of the media stream in the encoding such that the duration of the part of the media stream is reduced by an amount of time corresponding to a delay of the time of generation of the second data packet derived from the information.

12. The communication device of claim 1, wherein the communication device is a mobile terminal.

13. The communication device of claim 1, wherein the first packet and the second packet are data link layer PDUs.

14. The communication device of claim 1, wherein the first packet and the second packet are MAC PDUs.

15. The communication device of claim 1, wherein the communication device is a base station.

16. The communication device of claim 1, wherein the base station is configured to receive the first packet and the second packet from another communication device which comprises the packet encoder.

17. The communication device of claim 1, wherein the first packet and the second packet are RTP packets.

18. The communication device of claim 1, wherein the time at which communication resources for sending the first packet are available is the time for which communication resources are allocated to the communication device for sending the first packet.

19. The communication device of claim 1, wherein the time at which communication resources for sending the first packet are available is the time for which communication resources are allocated to the communication device for sending the first packet by a communication network.

20. A method for controlling packet generation comprising
receiving a first packet supplied by a packet encoder;
determining a time difference between the time at which the first packet is ready to be sent and a time at which communication resources for sending the first packet are available;
generating information from which it is derivable when a second packet should be provided by the packet encoder based on the time difference;
transmitting the information to the packet encoder.
